(19) United States
(12) Patent Application Publication
(10) Pub. No.: US 2012/0230384 A1
(43) Pub. Date: Sep. 13, 2012

(54) STORAGE DEVICE, ELECTRONIC DEVICE, AND FREQUENCY BAND COMPENSATION LEVEL ADJUSTING METHOD

(75) Inventor: Makoto CHIBA, Kawasaki-shi (JP)

(73) Assignee: KABUSHIKI KAISHA TOSHIBA, Tokyo (JP)

(21) Appl. No.: 13/354,155

(22) Filed: Jan. 19, 2012

(30) Foreign Application Priority Data
Mar. 11, 2011 (JP) 2011-054477

(51) Int. Cl. H04L 27/01

(52) U.S. Cl. 375/233

(57) ABSTRACT

According to one embodiment, a storage device includes a first equalizer, a second equalizer, and an adjuster. The first equalizer compensates for a predetermined frequency band of a first signal transferred by a host via a storage interface and outputs the compensated first signal as a second signal. The second equalizer equalizes the second signal by decision feedback compensation. The adjuster adjusts the level of the frequency band compensation of the first equalizer based on the state of the decision feedback compensation.

### CROSS-REFERENCE TO RELATED APPLICATIONS

This application is based upon and claims the benefit of priority from prior Japanese Patent Application No. 2011-054477, filed Mar. 11, 2011, the entire contents of which are incorporated herein by reference.

### FIELD

Embodiments described herein relate generally to a storage device, an electronic device, and a frequency band compensation level adjusting method.

### BACKGROUND

Generally, a storage device, such as a hard disk drive or a solid-state drive, is connected to a host via a storage interface. The storage device comprises an interface controller. The interface controller controls the reception of a data signal transferred from the host and the transmission of a data signal to be transferred to the host. The receiver of the interface controller includes a signal equalizer for equalizing an input signal.

In recent years, the transfer rate of a data signal exchanged between the host and the storage device is getting higher and has reached to, for example, 6 gigabits per second (Gbps). As a signal equalizer applied to a receiver that receives such an ultrahigh-speed data signal of the order of Gbps, a signal equalizer comprising a first equalizer and a second equalizer is known.

The first equalizer compensates an input signal for its predetermined frequency band according to a preset frequency band compensation level. The second equalizer equalizes the signal whose predetermined frequency band has been compensated to a target signal by decision feedback compensation.

With the conventional technique, the second equalizer is influenced by the frequency band compensation level set in the first equalizer and by the characteristic of the signal transferred from the host and input to the storage device. For example, suppose a high-frequency-band-emphasized signal is input to the first equalizer when the preset frequency band compensation level specifies a high level as a level that compensates for a high-frequency band. In this case, a signal whose high-frequency band has been emphasized further is input to the second equalizer. In contrast, suppose that the first equalizer is supplied with a signal whose amplitude has been attenuated in a high-frequency band when the preset frequency band compensation level specifies a low level. In this case, a signal that requires a substantial amount of compensation in the high-frequency band is input to the second equalizer.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram showing an exemplary configuration of an electronic device comprising a storage device according to an embodiment;

FIG. 2 is a block diagram showing an exemplary configuration of a receiver of an interface controller in the embodiment;

FIG. 3 shows an example of the relationship of tap coefficients to tap values, depending on the transmission line length in the embodiment; and

FIG. 4 is a flowchart to explain the way an adjuster adjusts a high-frequency band compensation level in the embodiment.

### DETAILED DESCRIPTION

Various embodiments will be described hereinafter with reference to the accompanying drawings. In general, according to one embodiment, a storage device comprises a first equalizer, a second equalizer, and an adjuster. The first equalizer is configured to compensate for a predetermined frequency band of a first signal transferred by a host via a storage interface and to output the compensated first signal as a second signal. The second equalizer is configured to equalize the second signal by decision feedback compensation. The adjuster is configured to adjust the level of the frequency band compensation of the first equalizer based on the state of the decision feedback compensation.

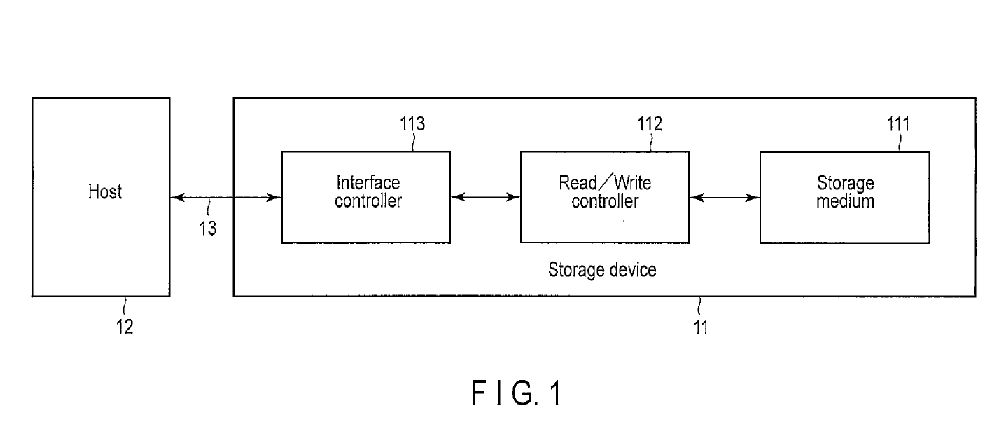

FIG. 1 is a block diagram showing an exemplary configuration of an electronic device comprising a storage device according to an embodiment. As shown in FIG. 1, the electronic device comprises a storage device 11 and a host 12. The storage device 11 and host 12 are connected to each other via a storage interface 13. The host 12 accesses the storage device 11 via the storage interface 13.

In the embodiment, the storage interface 13 is assumed to be a Serial Attached SCSI (SAS) interface whose transfer rate is on the order of Gbps. The storage interface 13 may be an interface other than the SAS interface. For instance, it may be a Serial ATA (SATA) interface.

The storage device 11 is a nonvolatile storage device, such as a hard disk drive (HDD) or a solid-state drive (SSD). The storage device 11 comprises a storage medium 111, a read/write controller 112, and an interface controller 113.

The storage medium 111 is, for example, a magnetic disk if the storage device 11 is an HDD or a rewritable nonvolatile memory, such as a flash memory, if the storage device 11 is an SDD. The read/write controller 112 controls the writing of data to the storage medium 111 and the reading of data from the storage medium 111.

The interface controller 113 controls the transmission and reception of a data signal to and from the host 12. The interface controller 113 comprises a receiver and a transmitter (both not shown). The receiver receives a data signal transferred from the host 12 via the storage interface 13. The transmitter transmits a data signal to the host 12 via the storage interface 13.

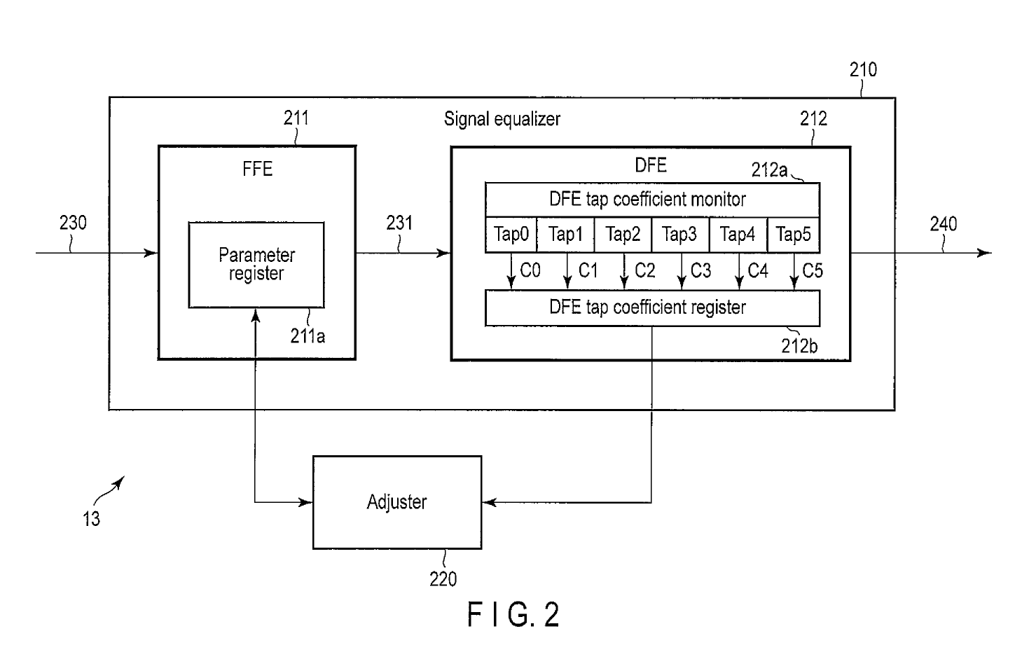

FIG. 2 is a block diagram showing an exemplary configuration of the receiver of the interface controller 113. The receiver of the interface controller 113 comprises a signal equalizer 210 and an adjuster 220. The signal equalizer 210 comprises a feedforward equalizer (FFE) 211 acting as a first equalizer and a decision feedback equalizer (DFE) acting as a second equalizer.

As is commonly known, the FFE 211 compensates for a frequency band of an input signal 230 (a first signal) according to a preset parameter (or a frequency band compensation level). The input signal 230 is a data signal that is transferred from the host 12 to the storage device 11 via the storage interface 13 and input to the interface controller 113 (more specifically, received by the receiver of the interface controller 113). The FFE 211 comprises a parameter register 211a for setting parameters (or FFE parameters). The FFE parameters include an FFE boost parameter and a low-frequency band compensation parameter.

The FFE boost parameter is a frequency band compensation parameter that specifies the boost level of the FFE 211. More specifically, the FFE boost parameter is a frequency band compensation parameter that specifies the boost level (i.e., the high-frequency band compensation level) of a frequency band (here, a high-frequency band) corresponding to the transfer rate of the input signal 230. The FFE 211 boosts the amplitude of the input signal 230 according to the FFE boost parameter, thereby compensating for a high-frequency band corresponding to the transfer rate. The low-frequency band compensation parameter specifies the correction level for compensating for the low-frequency band of the input signal 230. The FFE 211 compensates for the low-frequency band of the input signal 230 according to the low-frequency band compensation parameter.

The DFE 212 equalizes a signal 231 (a second signal, output by the FFE 211, whose frequency band has been compensated for to a target signal by decision feedback compensation. As a result, the DFE 212 outputs an equalized signal 240 (a third signal). The DFE 212 has a plurality of taps, for example, six taps 0 to 5 constituting a digital filter (not shown). That is, the DFE 212 is provided with tap 0 as a reference value of the signal 231. In addition, the DFE 212 has tap 1, tap 2, . . . , tap 5 provided in positions where the signal 231 is delayed for time intervals corresponding to one unit interval (UI), two UIs, . . . , five UIs of the transfer rate. The DFE 212 further comprises a known DFE tap coefficient monitor 212a and a DFE tap coefficient register 212b.

The DFE tap coefficient monitor 212a detects a shift at taps 0 to 5 (more specifically, a phase shift from a target signal at each of the delay points divided by taps 0 to 5) and performs a known determination process of representing the detected shifts at taps 0 to 5 as coefficients. In this way, the DFE tap coefficient monitor 212a determines a coefficient corresponding to the detected shift (error) at each of taps 0 to 5. The DFE tap coefficient monitor 212a feeds back a determined coefficient (i.e., determination result) corresponding to a shift at each of taps 0 to 5 as tap coefficients (DFE tap coefficients) C0 to C5 of taps 0 to 5 to be used next.

As in the embodiment, the data signal transferred from the host 12 to the storage device 11 is affected by the transmission line length of the storage interface 12 in high-speed transfer on the order of Gbps. For example, suppose the data signal is input as an input signal 230 to the signal equalizer 210 of the interface controller 113 of the storage device 11. In this case, the amplitude of the input signal 230 is influenced by the transmission line length and is attenuated in a high-frequency band, causing an amplitude difference between the high-frequency band and the low-frequency band. Then, a phase shift in the input signal 230 resulting from inter-symbol interference (ISI) has occurred. The DFE 212 corrects the phase shift by feedback based on the determination process.

The DFE tap coefficient register 212b holds DFE tap coefficients C0 to C5 of taps 0 to 5 determined by the DFE tap coefficient monitor 212a. DFE tap coefficients CO to C5 held by the DFE tap coefficient register 212b are used at taps 0 to 5, respectively.

The adjuster 220 reads a DFE tap coefficient from the DFE tap coefficient register 212b of the DFE 212. The adjuster 220 estimates (or determines) the degree of attenuation of the signal 231 (more specifically, the degree of attenuation of the high-frequency band of the signal 231) based on the read DFE tap coefficient. The estimation of the degree of attenuation will be explained in detail later. Based on the estimation result of the degree of attenuation, the adjuster 220 adjusts the frequency band compensation level (e.g., the high-frequency band compensation level). The adjusted frequency band compensation level is used for the FFE 211 to compensate for the frequency band (e.g., the high-frequency band) of the input signal 230.

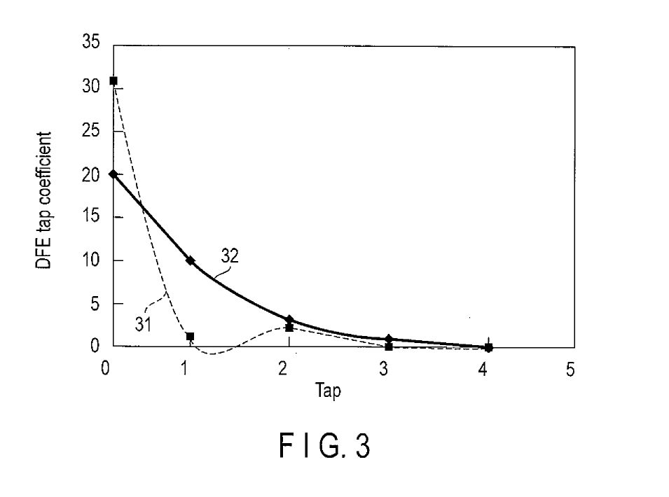

Here, typical DFE tap coefficients of taps 0 to 5 of the DFE 212 when the transmission line length of the storage interface 13 is short and long will be explained with reference to FIG. 3. FIG. 3 shows an example of the relationship of DFE tap coefficients to tap values (or tap positions), depending on the transmission line length.

In FIG. 3, curve 31 represents an example of the relationship of DFE tap coefficients to tap values (or tap positions) when the transmission line length is as short as L1 and curve 32 represents an example of the relationship of DFE tap coefficients to tap values (or tap positions) when the transmission line length is as long as L2 (L2>L1). Here, suppose the amplitude and transfer rate of a data signal on the data signal transmission side (or host 12) when the transmission line length is short are the same as those when the transmission line length is long. In addition, suppose the values of the parameters including the FFE boost parameter set in the parameter register 211a of the FFE 211 when the transmission line length is short are the same as those when the transmission line length is long.

The data signal output from the host 12 to the storage interface 13 is transferred to the storage device 11 via the storage interface 13. The data signal transferred to the storage device 11 is input as the input signal 230 to the FFE 211 of the signal equalizer 210. If the transmission line length is L1 (L1<L2), the attenuation (more specifically, the attenuation of amplitude) of the input signal 230 in a high-frequency band is small when the input signal 230 is input to the FFE 211. In this case, the attenuation of the signal 231 in a high-frequency band output from the FFE 211 and input to the DFE 212 is smaller than when the transmission line is L2. Therefore, the deviation at tap 1 (a second tap), a tap next to tap 0 (a first tap), from DFE tap coefficient C0 of tap 0 serving as a reference value become small. As is clear from curve 31, DFE tap coefficient C1 of tap 1 approaches zero.

When the transmission line length is L2 (L2<L1), the attenuation in a high-frequency band when the data signal from the host 12 is input as an input signal 230 to the FFE 211 of the signal equalizer 210 is large. The attenuation of the signal 231 in a high-frequency band output from the FFE 211 and input to the DFE 212 is larger than when the transmission line length is L1. Therefore, the deviation at tap 1 from DFE tap coefficient C0 of tap 0 serving as a reference value becomes large. As is clear from curve 32, DFE tap coefficient C1 of tap 1 becomes large.

This means that the degree of attenuation of the input signal 230 in the high-frequency band can be estimated from DFE tap coefficient C1 of tap 1. If the amplitude and transfer rate of the data signal on the data signal transmission side are constant, the transmission line length can be estimated from DFE tap coefficient C1 of tap 1.

As seen from the above explanation, the higher the degree of attenuation of the signal 230 (231) in the high-frequency band, the larger DFE tap coefficient C1 of tap 1 becomes. Therefore, in the embodiment, the adjuster 220 adjusts the high-frequency band compensation level so as to decrease DFE tap coefficient C1 based on DFE tap coefficient C1 of tap 1 held in the DFE tap coefficient register 212b of the DFE 212. The high-frequency band compensation level is used for the FEF 211 to compensate for the high-frequency band of the input signal 230. To adjust the high-frequency band compensation level, the adjuster 220 changes the values of the FFE boost parameter in the FFE parameters held in the parameter register 211a.

In the embodiment, suppose the adjuster 220 comprises a nonvolatile memory, such as a ROM, that stores firmware for adjustment and a microprocessor unit (MPU) that reads and runs the firmware. That is, the adjuster 220 is a software module realized by the MPU running the firmware. The adjuster 220 may be a hardware module.

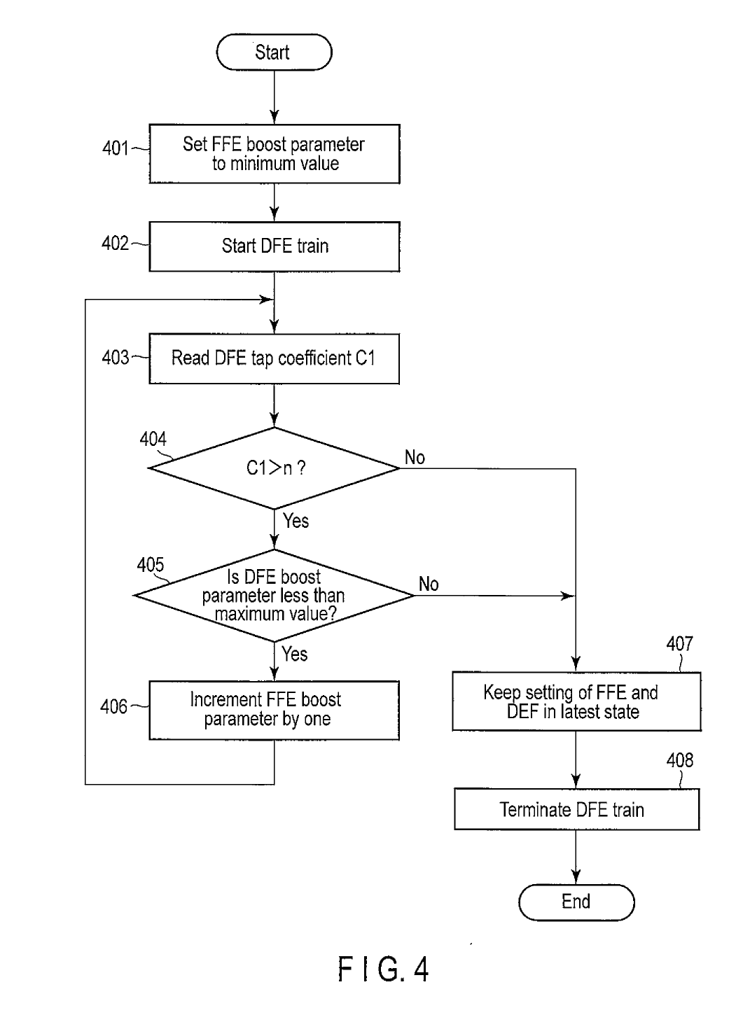

Hereinafter, the adjustment of the high-frequency band compensation level by the adjuster 220 will be explained with reference to the flowchart of FIG. 4. In the embodiment where the storage interface 13 is an SAS interface, the host 12 negotiates the transfer rate with the storage device 11. During a train period (or a DFE train period) for negotiating the transfer rate, the adjuster 220 adjusts the high-frequency band compensation level of the FFE 211, that is, the boost level in the high-frequency band (hereinafter, referred to as an FFE boost level). The FFE boost level of the FFE 211 is specified by the FFE boost parameter in the FFE parameters set in the parameter register 211a.

First, the adjuster 220 functions as a boost level change module and initially sets the FFE boost level to the lowest one (block 401). That is, the adjuster 220 initially sets the FFE boost parameter in the FFE parameters held in the parameter register 211a to the minimum value representing the lowest FFE boost level. In this state, the adjuster 220 starts a DFE train (block 402).

Next, the adjuster 220 functions as a tap coefficient read module and reads DFE tap coefficient C1 of tap 1 from the DFE tap coefficient register 212b of the DFE 212 (block 403). Next, the adjuster 220 functions as a determination module and determines whether read DFE tap coefficient Cl has exceeded threshold value n (block 404). Threshold value n is previously set to a value suited to the characteristic of the DFE 212. The characteristic of the DFE 212 is determined by a design approach or the like of the DFE 212.

If the read DFE tap coefficient C1 has exceeded threshold value n (Yes in block 404), the adjuster 220 determines (or presumes) that the degree of attenuation of the input signal 230 in the high-frequency band is high. In this case, the adjuster 220 determines that it is necessary to raise the FFE boost level so as to decrease DFE tap coefficient C1 of tap 1.

Then, the adjuster 220 proceeds to block 405 to determine whether there is room to raise the FFE boost level. In block 405, the adjuster 220 determines whether the FFE boost parameter held in the parameter register 211a is less than the maximum value representing the highest FFE boost level.

If the FFE boost parameter is less than the maximum value (Yes in bock 405), the adjuster 220 determines that there is room to raise the FFE boost level. Then, the adjuster 220 increments the value of the FFE boost parameter held in the parameter register 211a by one (block 406). That is, the adjuster 220 functions as a boost level change module and raises the FFE boost level by one.

Then, the FFE 211 boosts the amplitude of the input signal 230 in the high-frequency band at an FFE boost level one level higher than last time. As a result, the attenuation amount of the signal 231 in the high-frequency band output from the FFE 211 and input to the DFE 212 is smaller than last time. In this case, the value of DFE tap coefficient C1 of tap 1 readjusted (set) by the DFE tap coefficient monitor 212a of the DFE 212 becomes smaller than last time.

After having executed block 406, the adjuster 220 returns to block 403. In block 403, the adjuster reads new DFE tap coefficient C1 of tap 1 after the FFE boost level has been changed. In this way, the adjuster 220 repeats a loop of blocks 404 to 406 and block 403, thereby raising the FFE boost level stepwise.

Suppose the read DFE tap coefficient C1 has become equal to or less than threshold value n as a result of the adjuster 220 having raised the FFE boost level of the FFE 211 stepwise (No in block 404). In this case, the adjuster 220 determines that the attenuation of the signal 231 in the high-frequency band has been suppressed suitably. Then, the adjuster 220 functions as a boost level change module and keeps the setting of the FFE 211 and DFE 212 (more specifically, FFE parameters and DFE tap coefficients C0 to C5) in the latest state (block 407). The latest state of the FFE 211 and DFE 212 is a state where DFE tap coefficient C1 has become equal to or less than threshold value n.

That is, the adjuster 220 keeps the values of the FFE parameters including the FFE boost parameter held in the parameter register 211a of the FFE 211 in the state where DFE tap coefficient C1 has become equal to or less than threshold value n. The value of the FFE boost parameter in this state is the most suitable value for the transmission line length of the present storage interface 13. That is, the FFE boost level for compensating for the attenuation of the input signal 230 in the high-frequency band is adjusted to the optimum level for the transmission line length of the storage interface 13. The adjuster 220 further keeps DFE tap coefficients C0 to C5 of taps 0 to 5 including DFE tap coefficient C1 of tap 1 of the DFE 212 in the state where DFE tap coefficient Cl has become equal to or less than threshold value n. When the adjuster 220 has executed block 407, the DFE train is completed (block 408).

Next, suppose the FFE boost parameter has coincided with the maximum value although DFE tap coefficient C1 is still larger than threshold value n (No in block 405). That is, the FFE boost level has reached the highest level. In this case, since there is no room to raise the FFE boost level further, the adjuster 220 proceeds to block 407. In block 407, the adjuster 220 keeps the setting of the FFE 221 and DFE 212 in the latest state. At this time, the latest state of the FFE 221 and DFE 212 is a state where the FFE boost level has reached the highest level.

As described above, with the embodiment, the adjuster 220 reads a DFE tap coefficient (in this case, DFE tap coefficient C1 of tap 1) adjusted at the DFE 212 each time the adjuster 220 raises the FFE boost level of the FFE 211 stepwise, starting at the lowest level. DFE tap coefficient C1 represents the attenuation amount of the signal 231 in the high-frequency band (a predetermined high-frequency band) output from the FFE 211 and input to the DFE 212. Therefore, the adjuster 220 can estimate (or determine) the degree of attenuation of the signal 231 in the high-frequency band based on DFE tap coefficient C1 by reading DFE tap coefficient C1. The degree of attenuation of the signal 231 in the high-frequency band corresponds to the degree of attenuation of the input signal 230 in the high-frequency band if the FFE boost levels are the same.

The adjuster 220 repeats the operation of raising the FFE boost level and the operation of reading DFE tap coefficient C1 until the read DFE tap coefficient C1 becomes equal to or less than threshold value n. In this way, the adjuster 220 adjusts the FFE boost level (or high-frequency band compensation level) to a level suited to the degree of the estimated attenuation. This enables the adjuster 220 to compensate for the attenuation of the signal 230 (231) in the high-frequency band.

As described above, in high-speed transfer, the signal transferred from the host 12 to the storage device 11 is affected by the transmission line length. Therefore, each electronic, comprising the host 12 and storage device 11 (i.e., the storage device 11 connected to the host 12 via the storage interface 13), might differ in terms of the characteristic of a signal transferred from the host 12 to the storage device 11. In an electronic device where one storage device 11 is connected to a plurality of hosts including the host 12 via separate slots, the slots might differ in terms of the transmission line length. In this case, signals input to the respective slots of the storage device 11 differ in terms of the degree of attenuation of the signals in the high-frequency band. In either case, the signal equalizer 210 of the storage device 11 in the embodiment is capable of adjusting each degree of attenuation to an FFE boost level suited to the degree of attenuation in the high-frequency band of the input signal.

Hereinafter, the relationship between the FFE boost level and the-frequency band compensation will be explained by comparing a case where the FFE boost level is adjusted as in the embodiment with a case where the FFE boost level is not adjusted differently from the embodiment. First, a case where the adjustment of the FFE boost level is not applied will be explained.

Suppose the FFE 211 is used in a first state where the FFE boost level of the FFE 211 is set to a high level. In the first state, suppose a high-frequency-band-emphasized signal is input as an input signal 230 to the FFE 211. In this case, the FFE 211 boosts the high-frequency-band-emphasized signal at a high boost level. Since the FFE 211 inputs a signal whose high-frequency band has been further emphasized to the DFE 212, a correction margin in the DFE 212 decreases.

Next, suppose the FFE 211 is used in a second state where the FFE boost level of the FFE 211 is set to a low level. In the second state, suppose a high-frequency-band-attenuated signal is input as an input signal 230 to the FFE 211. In this case, too, a correction margin in the DFE 212 decreases. Therefore, when the adjustment of the FFE boost level is not applied, it is difficult to equalize an input signal 230 with a variety of characteristics suitably.

Next, a case where the adjustment of the FFE boost level is applied will be explained. First, suppose a high-frequency-band-emphasized signal is input as an input signal 230 to the FFE 211 in the first state. As described above, the adjuster 220 reads DFE tap coefficient C1 of tap 1 adjusted by the DFE 212 each time the adjuster 220 raises the FFE boost level stepwise, starting at the lowest level. The adjuster 220 repeats this operation until DFE tap coefficient C1 of tap 1 becomes equal to or less than threshold value n. In this case, the FFE boost level is set to a relatively low level suited to the high-frequency-band-emphasized signal. Next, the high-frequency-band-emphasized signal is input as an input signal 230 to the FFE 211 in the second state. In this case, the FFE boost level is set to a relatively high level suited to a high-frequency-band-attenuated signal.

As described above, in the embodiment, the FFE boost level of the FFE 211 is set suitably based on the degree of attenuation of the input signal in the high-frequency band. That is, according to the embodiment, the FFE parameter of the FFE 211 in the signal equalizer 210 provided on the reception side of the storage device 11 can be adjusted suitably based on the characteristic of a data signal sent from the host 12, the transmission line length of the storage interface 13, or the characteristic of the transmission line. This makes it possible to suppress a variation in the attenuation amount of amplitude in the high-frequency band of the signal 231 output from the FFE 211 and input to the DEF 212 and equalize an input signal with a variety of characteristics suitably. According to at least one of the embodiments explained above, it is possible to provide a storage device, an electronic device, and a frequency band compensation level adjusting method which are capable of adjusting the frequency band compensation level of an equalizer so as to be suited to the degree of attenuation of an input signal in a predetermined frequency band.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device comprising:
a first equalizer configured to compensate for a first frequency band of a first signal input by a host via a storage interface and to output the compensated first signal as a second signal;
a second equalizer configured to equalize the second signal by decision feedback compensation; and
an adjuster configured to adjust a level of the frequency band compensation of the first equalizer based on a state of the decision feedback compensation.

2. The storage device of claim 1, wherein:
the second equalizer comprises a decision feedback equalizer which comprises a plurality of taps and is configured to adjust a tap coefficient of each of the plurality of taps by the decision feedback compensation; and
the adjuster is further configured to use the adjusted tap coefficient of a first one of the plurality of taps as the state of the decision feedback compensation.

3. The storage device of claim 2, wherein:
the first equalizer comprises a feedforward equalizer; and
the level of the frequency band compensation is a boost level representing a level at which a high-frequency band of the input signal is boosted.

4. The storage device of claim 3, wherein the adjuster comprises:
a tap coefficient read module configured to read the adjusted tap coefficient of the first tap;
a determination module configured to determine a degree of attenuation of amplitude of the second signal in the high-frequency band based on the read tap coefficient; and
a boost level change module configured to change the boost level based on the determined degree of attenuation.

5. The storage device of claim 4, wherein:
the determination module is configured to determine that the degree of attenuation is high if the read tap coefficient has exceeded a first threshold value; and
the boost level change module is configured to raise the boost level if it has been determined that the degree of attenuation is high.

6. The storage device of claim 5, wherein:
the tap coefficient read module is configured to read an adjusted latest tap coefficient each time the boost level is raised;
the determination module is further configured to determine that the degree of attenuation is suitable if the read tap coefficient has become less than the threshold value; and
the boost level change module is configured to keep the setting of at least the boost level in the first equalizer and the setting of at least the tap coefficient of the first tap in the second equalizer in a latest state if it has been determined that the degree of attenuation is suitable.

7. The storage device of claim 6, wherein the boost level change module is further configured to set the boost level to a lowest level when the adjustment of the boost level is started.

8. An electronic device comprising:
a storage device; and
a host connected to the storage device via a storage interface,
wherein the storage device comprises:
a first equalizer configured to compensate for a first frequency band of a first signal input by the host via the storage interface and to output the compensated first signal as a second signal;
a second equalizer configured to equalize the second signal by decision feedback compensation; and
an adjuster configured to adjust a level of the frequency band compensation of the first equalizer based on a state of the decision feedback compensation.

9. The electronic device of claim 8, wherein:
the second equalizer comprises a decision feedback equalizer which comprises a plurality of taps and is configured to adjust a tap coefficient of each of the plurality of taps by the decision feedback compensation; and
the adjuster is further configured to use the adjusted tap coefficient of a first one of the plurality of taps as the state of the decision feedback compensation.

10. The electronic device of claim 9, wherein:
the first equalizer comprises a feedforward equalizer; and
the level of the frequency band compensation is a boost level representing a level at which a high-frequency band of the input signal is boosted.

11. The electronic device of claim 10, wherein the adjuster comprises:
a tap coefficient read module configured to read the adjusted tap coefficient of the first tap;
a determination module configured to determine a degree of attenuation of amplitude of the second signal in the high-frequency band based on the read tap coefficient; and
a boost level change module configured to change the boost level based on the determined degree of attenuation.

12. The electronic device of claim 11, wherein:
the determination module is configured to determine that the degree of attenuation is high if the read tap coefficient has exceeded a first threshold value; and
the boost level change module is configured to raise the boost level if it has been determined that the degree of attenuation is high.

13. The electronic device of claim 12, wherein:
the tap coefficient read module is further configured to read an adjusted latest tap coefficient each time the boost level is raised;
the determination module is configured to determine that the degree of attenuation is suitable if the read tap coefficient has become less than the threshold value; and
the boost level change module is configured to keep the setting of at least the boost level in the first equalizer and the setting of at least the tap coefficient of the first tap in the second equalizer in a latest state if it has been determined that the degree of attenuation is suitable.

14. The electronic device of claim 13, wherein the boost level change module is further configured to set the boost level to a lowest level when the adjustment of the boost level is started.

15. A method of adjusting a frequency band compensation level in a storage device comprising a first equalizer and a second equalizer, the first equalizer being configured to compensate for a first frequency band of a first signal input by a host via a storage interface and to output the compensated first signal as a second signal, and the second equalizer being configured to equalize the second signal by decision feedback compensation, wherein the method comprises:
adjusting a level of the frequency band compensation of the first equalizer based on a state of the decision feedback compensation by the second equalizer.

16. The method of claim 15, wherein:
the second equalizer comprises a decision feedback equalizer which comprises a plurality of taps and is configured to adjust a tap coefficient of each of the plurality of taps by the decision feedback compensation; and
the method further comprises using the adjusted tap coefficient of a first one of the plurality of taps as the state of the decision feedback compensation.

17. The method of claim 16, wherein:
the first equalizer comprises a feedforward equalizer; and
the level of the frequency band compensation is a boost level representing a level at which a high-frequency band of the input signal is boosted.

18. The method of claim 17, further comprising:
reading the adjusted tap coefficient of the first tap;
determining a degree of attenuation of amplitude of the second signal in the high-frequency band based on the read tap coefficient; and
changing the boost level based on the determined degree of attenuation.

19. The method of claim 18, wherein:
the determining the degree of attenuation comprises determining that the degree of attenuation is high if the read tap coefficient has exceeded a first threshold value; and
the changing comprises raising the boost level if it has been determined that the degree of attenuation is high.

20. The method of claim 19, wherein:
the reading comprises reading an adjusted latest tap coefficient each time the boost level is raised;
the determining the degree of attenuation further comprises determining that the degree of attenuation is suitable if the read tap coefficient has become less than the threshold value; and
the method further comprises keeping the setting of at least the boost level in the first equalizer and the setting of at least the tap coefficient of the first tap in the second equalizer in a latest state if it has been determined that the degree of attenuation is suitable.
